(19) United States
(12) Patent Application Publication
(10) Pub. No.: US 2024/0235930 A1
(43) Pub. Date: Jul. 11, 2024

(54) METHOD AND APPARATUS TO PROVIDE EDGE COMPUTING SERVICE INFORMATION VIA A WIRELESS COMMUNICATION SYSTEM

(71) Applicant: Samsung Electronics Co., Ltd., Suwon-si (KR)

(72) Inventors: Hyesung KIM, Suwon-si (KR); Cheolung LEE, Suwon-si (KR)

(21) Appl. No.: 18/405,714

(22) Filed: Jan. 5, 2024

(30) Foreign Application Priority Data
Jan. 6, 2023 (KR) 10-2023-0002255

(51) Int. Cl. H04L 41/0806; H04L 67/51

(52) U.S. Cl. CPC H04L 41/0806; H04L 67/51

(57) ABSTRACT

The disclosure relates to a 5G or 6G communication system for supporting higher data rates. The disclosure provides a method of providing edge computing service information through application triggering in an edge computing system. More specifically, the disclosure provides a method and device for utilizing device triggering or application triggering providing interworking in a wireless communication system between an edge enabler client (EEC), an edge enabler server, and an edge configuration server (ECS) constituting an edge computing system.

### CROSS-REFERENCE TO RELATED APPLICATION

This application is based on and claims priority under 35 U.S.C. § 119 to Korean Patent Application No. 10-2023-0002255, filed on Jan. 6, 2023, in the Korean Intellectual Property Office, the disclosures of which are herein incorporated by reference in their entireties.

### 1. FIELD

The disclosure relates to a wireless communication system and an edge computing system, and more particularly, to a method and device for providing edge computing service information through a mobile communication system.

### 2. DESCRIPTION OF RELATED ART

5G mobile communication technology defines a wide frequency band to enable a fast transmission speed and new services, and may be implemented not only in a frequency (‘sub 6 GHz’) band of 6 GHz or less such as 3.5 GHz, but also in an ultra high frequency band (‘above 6 GHz’) called a mmWave such as 28 GHz and 39 GHz. Further, in the case of 6G mobile communication technology, which is referred to as a beyond 5G system, in order to achieve a transmission speed that is 50 times faster than that of 5G mobile communication technology and ultra-low latency reduced to 1/10 compared to that of 5G mobile communication technology, implementations in terahertz bands (e.g., such as 95 GHz to 3 terahertz (3 THz) band) are being considered.

In the early days of 5G mobile communication technology, with the goal of satisfying the service support and performance requirements for an enhanced mobile broadband (eMBB), ultra-reliable low-latency communications (URLLC), and massive machine-type communications (mMTC), standardization has been carried out for beamforming and massive MIMO for mitigating a path loss of radio waves in an ultra-high frequency band and increasing a propagation distance of radio waves, support for various numerologies (multiple subcarrier spacing operation, and the like) for efficient use of ultra-high frequency resources and dynamic operation for slot formats, initial access technology for supporting multi-beam transmission and broadband, a definition and operation of a band-width part (BWP), a new channel coding method such as low density parity check (LDPC) code for large capacity data transmission and polar code for high reliable transmission of control information, L2 pre-processing, and network slicing that provides a dedicated network specialized for specific services.

Currently, discussions are ongoing to improve initial 5G mobile communication technology and enhance a performance thereof in consideration of services that 5G mobile communication technology was intended to support, and physical layer standardization for technologies such as vehicle-to-everything (V2X) for helping driving determination of an autonomous vehicle and increasing user convenience based on a location and status information of the vehicle transmitted by the vehicle, new radio unlicensed (NR-U) for the purpose of a system operation that meets various regulatory requirements in unlicensed bands, NR UE power saving, a non-terrestrial network (NTN), which is direct UE-satellite communication for securing coverage in areas where communication with a terrestrial network is impossible, and positioning is in progress.

Further, standardization in the field of air interface architecture/protocol for technologies such as industrial Internet of things (IIoT) for supporting new services through linkage and convergence with other industries, integrated access and backhaul (IAB) that provides nodes for expanding network service areas by integrating wireless backhaul links and access links, mobility enhancement including conditional handover and dual active protocol stack (DAPS) handover, and 2-step RACH for NR that simplifies a random access procedure is also in progress, and standardization in the field of system architecture/service for 5G baseline architecture (e.g., service based architecture, service based interface) for applying network functions virtualization (NFV) and software-defined networking (SDN) technologies, mobile edge computing (MEC) that receives services based on a location of a UE, and the like is also in progress.

When such a 5G mobile communication system is commercialized, connected devices in an explosive increase trend will be connected to communication networks; thus, it is expected that function and performance enhancement of a 5G mobile communication system and integrated operation of connected devices will be required. To this end, new research on extended reality (XR) for efficiently supporting augmented reality (AR), virtual reality (VR), mixed reality (MR), and the like, 5G performance improvement and complexity reduction using artificial intelligence (AI) and machine learning (ML), AI service support, metaverse service support, and drone communication will be conducted.

Further, the development of such a 5G mobile communication system will be the basis for the development of full duplex technology for improving frequency efficiency and system network of 6G mobile communication technology, satellite, AI-based communication technology that utilizes artificial intelligence (AI) from a design stage and that realizes system optimization by internalizing end-to-end AI support functions, and next generation distributed computing technology that realizes complex services beyond the limits of UE computing capabilities by utilizing ultra-high-performance communication and computing resources as well as a new waveform for ensuring coverage in a terahertz band of 6G mobile communication technology, full dimensional MIMO (FD-MIMO), multi-antenna transmission technologies such as an array antenna and large scale antenna, metamaterial-based lenses and antennas for improving coverage of terahertz band signals, high-dimensional spatial multiplexing technology using orbital angular momentum (OAM), and reconfigurable intelligent surface (RIS) technology.

If edge data network configuration information or edge application server (EAS) information stored in an ECS or EES is changed, a notification service according to such a change should be provided to an EEC. In this case, in order to provide the notification service, a connection state between the EEC and the EES/ECS should be continuously maintained, and as a keep-alive operation for this is performed, terminal power consumption may increase. As a method for solving this problem, there is a device triggering method provided by a wireless communication system, but because procedures to be performed between the EEC and the EES are diverse, a method of determining which procedure to perform is required.

### SUMMARY

The disclosure provides a method for selecting and performing necessary procedures between an EEC and an EES/ECS while solving the above-described problems.

According to an embodiment of the disclosure for solving the above problems, a method performed by a terminal in a communication system may include transmitting, by an edge enabler client (EEC) of the terminal to a server of an edge data network (EDN), a request message including an indication indicating that EEC triggering is requested, the server of the EDN including an edge configuration server (ECS) or an edge enabler server (EES); receiving, from the server, a message including information on a trigger payload based on the request message; and performing a procedure selected based on the trigger payload, wherein the trigger payload may include information indicating a procedure over EDGE-1 or a procedure over EDGE-4.

Further, according to an embodiment of the disclosure, a method performed by a server of an edge data network (EDN) in a communication system may include receiving, from a terminal, a request message including an indication indicating that edge enabler client (EEC) triggering is requested; and transmitting, to the terminal, a message including information on a trigger payload based on the request message, the trigger payload including information indicating a procedure over EDGE-1 or a procedure over EDGE-4, wherein the server may include an edge configuration server (ECS) or an edge enabler server (EES), and wherein a procedure selected based on the trigger payload may be performed with the ECS or the EES.

Further, according to an embodiment of the disclosure, a terminal in a communication system may include a transceiver; and a controller including an edge enabler client (EEC) configured to control the transceiver to transmit, to a server of an edge data network (EDN), a request message including an indication indicating that EEC triggering is requested, the server including an edge configuration server (ECS) or an edge enabler server (EES), to control the transceiver to receive, from the server, a message including information on a trigger payload based on the request message and to perform a procedure selected based on the trigger payload, wherein the trigger payload may include information indicating a procedure over EDGE-1 or a procedure over EDGE-4.

Further, according to an embodiment of the disclosure, a server of an edge data network (EDN) in a communication system may include a transceiver; and a controller configured to control the transceiver to receive, from a terminal, a request message including an indication indicating that edge enabler client (EEC) triggering is requested, and to control the transceiver to transmit, to the terminal, a message including information on a trigger payload, based on the request message, the trigger payload including information indicating a procedure over EDGE-1 or a procedure over EDGE-4, wherein the server of the EDN may include an edge configuration server (ECS) or an edge enabler server (EES), and wherein a procedure selected based on the trigger payload may be performed with the ECS or the ESS.

### BRIEF DESCRIPTION OF THE DRAWINGS

In relation to the description of the drawings, the same or similar reference numerals may be used for identical or similar components.

FIG. 1 is a block diagram illustrating a structure of an edge computing system according to an embodiment of the disclosure.

FIG. 2 is a signal flow diagram illustrating an EEC triggering procedure of an ECS according to an embodiment of the disclosure.

FIG. 3 is a signal flow diagram illustrating an EEC triggering procedure of an EES according to an embodiment of the disclosure.

FIG. 4 is a block diagram illustrating a structure of a terminal according to an embodiment of the disclosure.

FIG. 5 is a block diagram illustrating a structure of a server on an edge computing system according to an embodiment of the disclosure.

FIG. 6 is a block diagram illustrating a structure of a network function entity according to an embodiment of the disclosure.

### DETAILED DESCRIPTION

Hereinafter, an operating principle of the disclosure will be described in detail with reference to the attached drawings. Terms described below are terms defined in consideration of functions in the disclosure. Because this may vary according to the intention or custom of the user or operator, the definition should be determined according to the contents throughout this specification.

Terms referring to network entities and objects of an edge computing system, terms referring to messages, terms referring to identification information, and the like used in this disclosure are exemplified for convenience of description. Accordingly, it is obvious to those skilled in the art that the disclosure is not limited to the terms described below, and that other terms referring to objects having equivalent technical meaning may be used.

Hereinafter, for convenience, the disclosure uses terms and names defined in the 5G system standard, but it is not limited by the terms and names, and may be equally applied to systems that comply with other standards.

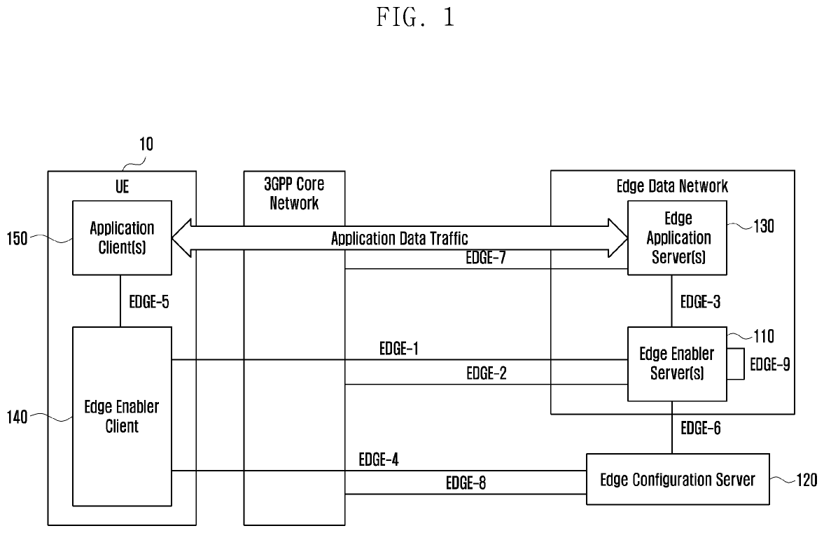

FIG. 1 is a block diagram illustrating an example of an edge computing system.

The edge computing system may include an edge enabler server (EES) 110, edge configuration server (ECS) 120, and edge enabler client (EEC) 140.

The EES 110 is constructing an edge hosting environment (or edge computing platform) and knows information on an edge application server (EAS) 130 running in the edge hosting environment. The EES 110 negotiates with a user equipment (a UE 10 of FIG. 1) and performs a function of connecting an application client 150 of the UE 10 and the EAS 130 in the edge hosting environment. The UE that supports the edge computing system may have the built-in EEC 140, and the negotiation may be carried out through interconnection between the EEC 140 and the EES 110. For the above negotiation, a layer that performs interconnection between the EEC 140 and the EES 110 may be referred to as an edge enabling layer. The UE 10 described in this disclosure includes not only a smartphone but also an Internet of things (IOT) device and vehicle.

The ECS 120 knows deployment information of the EES 110 and performs a function of delivering configuration information for using edge computing services to the UE. Here, the configuration information may include edge data network connection information (e.g., data network name, signal-network slice selection assistance information (S-NSSAI), and the like), edge data network service area information (e.g., cell list, list of tracking area, public land mobile network (PLMN) identity (ID), or edge enabler server connection information (e.g., uniform resource identifier (URI)). Edge data network service area information may be information on an edge enabler server available area configured by the EES 110. Based on this, the UE may acquire edge enabler server information accessible at a specific location. When the ECS 120 may obtain information on the edge enabler server running within the edge hosting environment of a specific edge enabler server, the UE 10 may obtain information on the edge application server through the EEC 140.

The EAS 130 means a third-party application server running within the edge computing system. More specifically, the EAS 130 is a third-party application server that runs on the premise of infrastructure provided in the edge hosting environment, and may provide ultra-low latency services because the EAS 130 may provide services at a location close to the UE.

Within the UE 10, there may be an application client 150, an EEC 140 that links the edge computing service with the application client 150, and a mobile terminal (MT) not illustrated in the drawing and that accesses the mobile communication system. An application of the UE 10 is an application provided by a third party and means a client application that runs within the UE for a specific application service. Several applications may be run within the UE. At least one of these applications may use mobile edge computing or multi-access edge computing (MEC) services.

The EEC 140 in the UE 10 means a client that performs operations within the UE required to use edge computing services. The EEC 140 may determine which application may use the edge computing service and perform an operation that connects the network interface so that data of the UE application client 150 may be transmitted to the EAS 130 that provides the edge computing service. Here, an operation of establishing a data connection for using edge computing services may be performed at the 3GPP communication layer through the mobile terminal. The 3GPP communication layer means a layer that performs modem operations for using the mobile communication system and performs the role of establishing a wireless connection for data communication, registering a UE in the mobile communication system, establishing a connection for data transmission to the mobile communication system, and transmitting and receiving data.

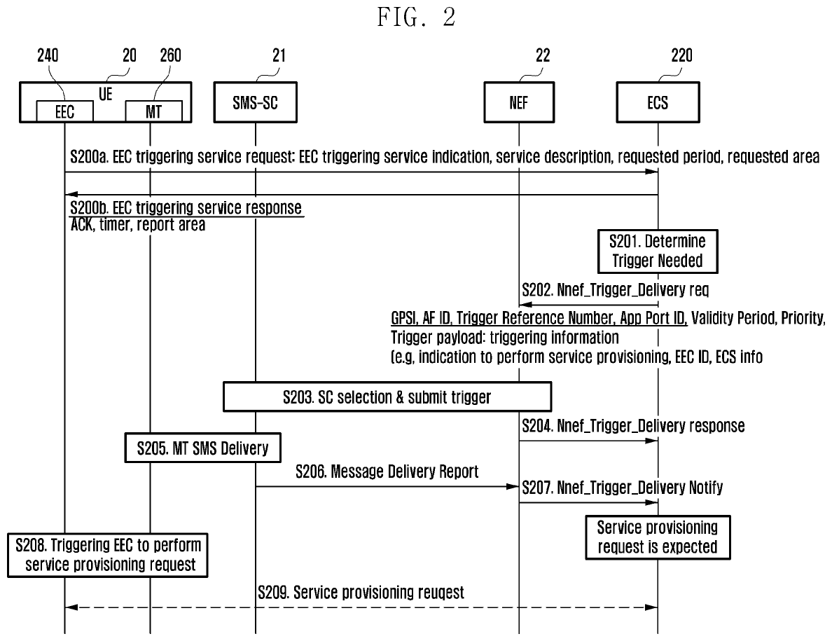

FIG. 2 is a signal flow diagram illustrating an EEC triggering procedure of an ECS according to an embodiment of the disclosure.

With reference to FIG. 2, an EEC 240 identifies whether at least one of short message service (SMS) over non-access stratum (NAS) or SMS over internet protocol (IP) within a UE 20 is supported. Further, when the UE 20 supports at least one of SMS over NAS or SMS over IP, and the EEC 240 supports a device triggering or application triggering operation (e.g., when the EEC may perform decoding for a payload within SMS information and perform a procedure according to information indicated by an ECS 220 in the payload), the EEC 240 may transmit an EEC triggering service request triggering to perform a procedure using EDGE-1 or EDGE-4 to the EEC to the ECS 220 (S200a).

Here, the EEC triggering service request transmission message may include at least one of information such as an EEC triggering request indication, triggering service description (service provisioning), triggering service period, triggering service area, port ID, UE ID, or EEC ID. Further, the triggering service description may include information on a procedure that should be triggered or a service that should be invoked in the EEC. Further, the triggering service period and triggering service area information may include information on a time and area at which the ECS 220 should perform EEC triggering.

The ECS 220 transmits, to the EEC 240, a response on whether the ECS 220 may successfully support the EEC triggering service corresponding to the request of the EEC 240 (S200b). For example, in the case that the ECS 220 may successfully support the EEC triggering service, the ECS 220 may generate a triggering service indication (or triggering service subscription indication) and provide the triggering service indication to the EEC 240 through a response message of S200b. The ECS 220 may map, store, and manage the generated triggering service indication and EEC ID, UE ID, triggering service description (service provisioning), triggering service period, triggering service area, or port ID. Further, the EEC 240 may map, store, and manage the triggering service indication, EEC ID, UE ID, triggering service description (service provisioning), triggering service period, triggering service area, or port ID, and the like received from the ECS 220. Here, the triggering service indication and stored information may be used in order for the EEC 240 or the ECS 220 to stop or modify the EEC triggering service in the future. For example, the EEC 240 may request stop of the EEC triggering service while transmitting a triggering service indication, EEC ID, UE ID, and triggering service description to the ECS 220. The ECS 220 that has received a stop request from the EEC 240 may determine a service to be stopped between an EEC triggering service stop target and the corresponding EEC 240 based on the triggering service indication, EEC ID, UE ID, and triggering service description included in the EEC triggering service stop request and transmit the result on whether stop to the EEC 240. As another example, the ECS 220 itself (without a separate request from the EEC) may determine to stop the EEC triggering service for a specific EEC 240. In this case, the ECS 220 may notify the EEC triggering service stop while transmitting the EEC triggering service indication, EEC ID, and stop target EEC triggering service description to the stopped EEC triggering service target EEC 240.

The ECS 220 may determine whether EEC triggering is required (S201). For example, the ECS 220 may detect a change in edge data network configuration information (EES address information, data network name (DNN) or S-NSSAI of an edge data network, EES service area information, edge data network (EDN) service area information, and the like) or may determine to perform EEC triggering in the case that the edge data network configuration information needs to be updated according to the movement of the UE 20 including the EEC 240.

When it is determined to perform EEC triggering, the ECS 220 may request a trigger delivery service while providing a trigger payload or a triggering service deadline including a UE identifier, a generic public subscription identifier (GPSI), an application function (AF) ID, a trigger reference number, an App port ID, validity period, priority, triggering information (triggering service description, indication to perform service provisioning, EEC ID, ECS info (ECS address and identifier) to a network exposure function (NEF) 22 (S202).

The NEF 22 may select an SMS-SC in association with 5G core network functions (e.g., user data management, access and mobility management function) and an SMS service center (SMS-SC) 21, and transmit the trigger received from the ECS 220 to the selected SMS-SC 21 (S203).

Further, the NEF 22 may transmit, to an ECS 220, a response message indicating that the trigger has been successfully delivered to the SMS-SC 21 (S204).

The SMS-SC 21 transmits an SMS to an MT 260 of the UE in association with the 5G core network (S205).

Further, the SMS-SC 21 transmits, to the NEF 22, message delivery report information on whether the SMS was successfully transmitted to the UE 20 (S206).

The NEF 22 may provide, to the ECS 220, information on whether a triggering message has been successfully transmitted to the UE 20 and acquired from the SMC-SC 21 (S207). In this case, when the ECS 220 receives such information from the NEF 22, the ECS 220 may predict that the EEC 240 will perform service provisioning.

The MT 260 of the UE may request to perform service provisioning while providing a port ID, EEC ID, ECS info, and triggering service description information included in the SMS received from the SMS-SC 21 to the EEC 240 (S208).

The EEC 240 performs a service provisioning request based on information received through the above-described procedure (S209). While performing a service provisioning request, the EEC 240 may acquire updated edge data configuration information (EES address information, DNN or S-NSSAI of the edge data network, EES service area information, EDN service area information, and the like) from the ECS 220.

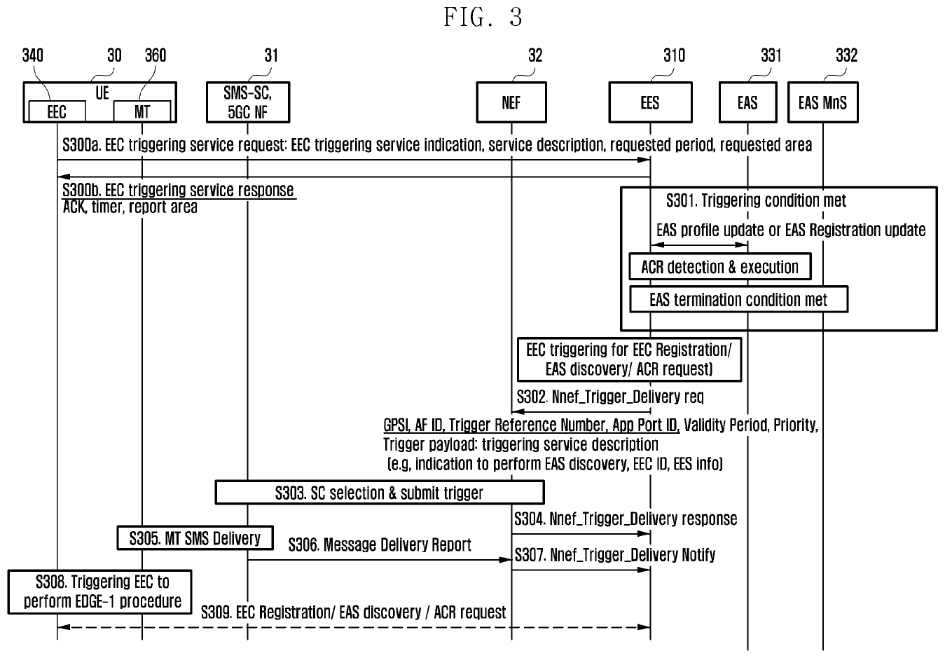

FIG. 3 is a signal flow diagram illustrating an EEC triggering procedure of an EES according to an embodiment of the disclosure.

With reference to FIG. 3, an EEC 340 identifies whether a UE 30 supports at least one of SMS over NAS or SMS over IP. Further, when the UE supports at least one of SMS over NAS or SMS over IP, and the EEC 340 supports a device triggering or application triggering operation (e.g., when the EEC may perform decoding on a payload in SMS information and perform a procedure according to information indicated by the ECS in the payload), the EEC 340 may transmit an EEC triggering service request to an EES 310 (S300a).

Here, the EEC triggering service request transmission message may include at least one of information such as an EEC triggering request indication, triggering service description (service provisioning, EAS discovery, EEC registration, application context relocation request), triggering service period, triggering service area, port ID, or EEC ID. Further, the triggering service description may include information on a procedure that should be triggered or a service that should be invoked in the EEC 340 or may include EES providing service procedure information (at least one procedure or service information of EAS discovery, EEC registration, or application context relocation) in which the EEC 340 wants to receive a request to perform through the EEC triggering service. Further, the triggering service period and triggering service area information may include information on a time and area at which the EES 310 should perform EEC triggering.

The EES 310 transmits a response on whether the EES 310 may successfully support an EEC triggering service according to the request of the EEC 340 (S300b). For example, in the case that the EES 310 may successfully support the EEC triggering service, the EES 310 may generate a triggering service indication (or triggering service subscription indication) and provide the triggering service indication to the EEC 340 through a response message of S300b. The EES 310 may map, store, and manage the generated triggering service indication and EEC ID, UE ID, triggering service description (service provisioning), triggering service period, triggering service area, or port ID. Further, the EEC 340 may map, store, and manage the triggering service indication, EEC ID, UE ID, triggering service description (service provisioning), triggering service period, triggering service area, or port ID received from the EES 310. Here, the triggering service indication and the stored information may be used when the EEC 340 or the EES 310 stops or modifies the EEC triggering service in the future. For example, the EEC 340 may request stop of the EEC triggering service while transmitting a triggering service indication, EEC ID, UE ID, and triggering service description to the EES 310. The EES 310 that has received a request for stop from the EEC 340 may determine a stop service with the EEC triggering service stop target EEC 340 through the triggering service indication, EEC ID, UE ID, and triggering service description included in the EEC triggering service stop request, and transmit information indicating whether to stop the EEC triggering service to the EEC 340. As another example, the EES 310 itself may determine to stop the EEC triggering service for a specific EEC 340. In this case, the EES 310 may notify EEC triggering service stop while transmitting the EEC triggering service indication, EEC ID, EES ID, and stop target EEC triggering service description to the stopped EEC triggering service target EEC 340.

The EES 310 may detect a change in EAS profile information (EAS address information, EAS DNN or S-NSSAI, EAS service area information, EAS data network access indication, EAS service KPI information, and the like) or may determine to perform EEC triggering in the case that EAS information update, application context relocation, or EEC registration is required according to a movement of the UE 30 including the EEC 340 (S301).

For example, the EES 310 identifies EAS profile information provided by an EAS 331 through an EAS registration procedure between the EAS 331 and the EES 310, and EAS profile information may be updated by determining to perform EEC triggering based on the EAS profile information. Further, as an example, in the case that it is determined that new EAS selection and application context relocation (ACR) are required according to a movement of the UE 30 or EAS overload, EEC triggering may be determined by the EES 310. Further, as an example, in the case that an EAS management system (MnS) 332 requests information related to potential service demand for the EAS 331 to the EES 310 in order to determine whether to perform EAS termination in consideration of an EAS usage frequency or service provision state, in order to identify potential service request demands for the EAS 331 from the EEC 340 currently registered in the EES 310, the EES 310 may determine to perform EEC triggering for enabling to perform an EEC registration procedure.

The EES 310 that has determined to perform EES triggering may request a trigger delivery service while providing a UE identifier, GPSI, AF ID, trigger reference number, app port ID, validity period, priority, triggering information (triggering service description, indication to perform service provisioning, or trigger payload including EAS discovery, EEC ID, EES info (EES address and identifier), EAS identifier and address information, triggering service deadline, and the like, as illustrated in the drawing to the NEF 32 (S302).

The NEF 32 may select an SMS-SC 31 in association with 5G core network functions (e.g., user data management, access and mobility management function) and the SMS service center (SMS-SC) 31 and transmit the trigger received from the EES 310 to the selected SMS-SC 31 (S303).

Further, the NEF 32 may transmit a response message indicating that the trigger has been successfully delivered to the SMS-SC 31 to the EES 310 (S304).

The SMS-SC 31 transmits an SMS to an MT 360 of the UE 30 in association with the 5G core network (S305).

Further, the SMS-SC 31 transmits, to the NEF 32, message delivery report information on whether the SMS was successfully transmitted to the UE 30 (S305).

The NEF 32 may provide information on whether the triggering message has been successfully transmitted to the UE 30 and received from the SMS-SC 31 to the EES 310. In this case, when the EES 310 receives the corresponding information from the NEF 32, the EES 310 may predict that the EEC 340 will perform a procedure according to the triggering service description.

The MT 360 of the UE 30 may trigger to perform an EDGE-1 procedure while providing a port ID, EEC ID, EES info (identifier and address information), triggering service description information, and triggering service deadline included in the received SMS to the EEC 340 (S308).

The EEC 340 performs appropriate procedures based on information received through the above-described procedures (S309).

For example, the EEC 340 performs a procedure identified based on triggering service description information for the EES 310 identified by EES info. As another example, in the case that the triggering service description information includes information on the EAS discovery procedure, the EEC 340 transmits an EAS discovery request to the EES 310 based on this. As another example, when EAS profile information is included in the triggering service description information, the EEC 340 may transmit an EAS discovery request to the EES 310 using the corresponding EAS profile information as EAS discovery filter information. Further, as an example, in the case that triggering service description information includes information on the application context relocation procedure, the EEC 340 acquires edge data network configuration information using edge data network configuration information stored in the UE 30 or performing service provisioning in the ECS and then performs an EAS discovery procedure for the identified EES 310 using the corresponding edge data network configuration information. Further, the EEC 340 may transmit an application context relocation request including EAS information (address and identifier) acquired through the EAS discovery procedure and information (address and identifier) on the EES 310, which is the target that performs the EAS discovery procedure to the EES 310 that has performed EEC triggering.

Further, as an example, in the case that the triggering service description information includes information on the EEC registration procedure, the EEC 340 may determine whether to perform the EEC registration procedure for the EES 310. For example, in the case that the triggering service description information includes information on the EEC registration procedure and information on a specific EAS, the EEC 340 may determine whether to transmit an EEC registration request message to the EES 310 by considering whether an application client that may request a service to the specific EAS is installed in the UE 30 or whether an installed application client requests the service.

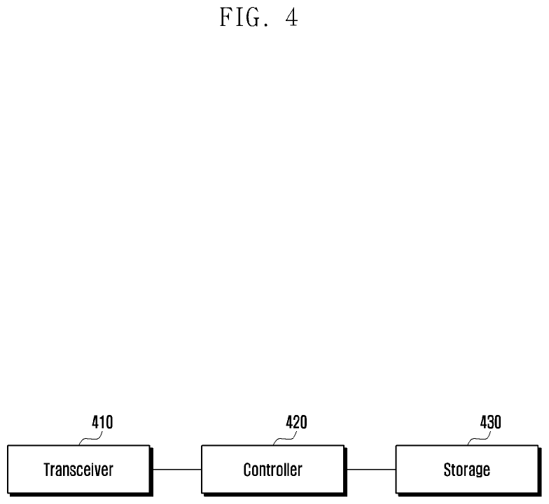

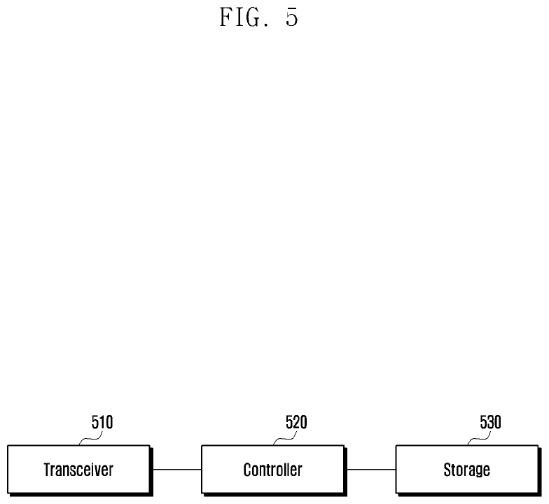

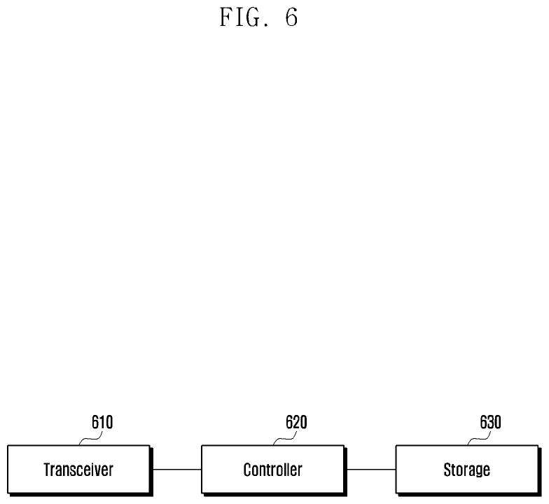

FIG. 4 is a block diagram illustrating a structure of a UE according to an embodiment of the disclosure, FIG. 5 is a block diagram illustrating a structure of a server on an edge computing system according to an embodiment of the disclosure, and FIG. 6 is a block diagram illustrating a structure of a network function entity according to an embodiment of the disclosure.

With reference to FIG. 4, a UE according to an embodiment of the disclosure may include a transceiver 410, a controller 420, and a storage 430. In the disclosure, the controller may be defined as a circuit, an application-specific integrated circuit, or at least one processor.

The transceiver 410 may transmit and receive signals in association with other network entities or servers. The transceiver 410 may perform a function of an MT used for performing the operations described above with reference to FIGS. 2 and 3. The controller 420 may control the overall operation of the UE according to the embodiment proposed in this disclosure. For example, the controller 420 may control signal flow between each block to perform operations according to the signal flow diagram described above. Further, the controller 420 may perform a function of controlling client operations of an EEC and application that may interwork with an EES/ECS according to an embodiment of the disclosure described above.

The storage 430 may store at least one of information transmitted and received through the transceiver 410 or information generated through the controller 420.

With reference to FIG. 5, a server according to an embodiment of the disclosure may include a transceiver 510, a controller 520, and a storage 530. In the disclosure, the controller may be defined as a circuit, an application-specific integrated circuit, or at least one processor. The server of the disclosure may include, for example, an EAS, EES, or ECS on the edge computing system described above.

The transceiver 510 may transmit and receive signals to and from other network entities or UEs. The controller 520 may control the overall operation of the server according to the embodiment proposed in this disclosure. For example, the controller 520 may control signal flow between each block to perform operations according to the signal flow diagram described above.

The storage 530 may store at least one of information transmitted and received through the transceiver 510 or information generated through the controller 520.

With reference to FIG. 6, a network entity according to an embodiment of the disclosure may include a transceiver 610, a controller 620, and a storage 630. In the disclosure, the controller may be defined as a circuit, an application-specific integrated circuit, or at least one processor. The network entity of the disclosure may include, for example, a NEF for interworking with a UE through 5GC or a network function (NF) on 5GC.

The transceiver 610 may transmit and receive signals to and from other network entities, servers, or UEs. The controller 620 may control the overall operation of the server according to the embodiment proposed in this disclosure. For example, the controller 620 may control signal flow between each block to perform operations according to the signal flow diagram described above.

The storage 630 may store at least one of information transmitted and received through the transceiver 610 or information generated through the controller 620.

In the detailed description of the disclosure, specific embodiments have been described, but various modifications are possible without departing from the scope of the disclosure. Therefore, the scope of the disclosure should not be limited to the described embodiments, but should be determined not only by the scope of the claims described later, but also by equivalents to the scope of the claims.

In the above-described specific embodiments of the disclosure, components included in the disclosure have been expressed in the singular or the plural according to the presented specific embodiments. However, the singular or plural expression is appropriately selected for a presented situation for convenience of description, and the disclosure is not limited to the singular or plural components, and even if a component is represented in the plural, it may be composed of the singular, or even if a component is represented in the singular, it may be composed of the plural.

The embodiments disclosed in the specification and drawings described above merely present specific examples in order to easily describe the content of the disclosure and help understanding thereof, and they are not intended to limit the scope of the disclosure. Therefore, all changes or modified forms derived based on the technical idea of the disclosure in addition to the embodiments disclosed herein should be construed as being included in the scope of the disclosure.

According to an embodiment of the disclosure, continuously updated edge computing service information can be provided to an EEC in a terminal without the need to continuously maintain a connection state between the EEC and an ECS or EES.

Further, according to an embodiment of the disclosure, the EEC can appropriately perform necessary procedures in order to acquire EAS information or edge data network configuration information according to triggering information received through a core network without direct communication with the EES/ECS.

1. A method performed by a terminal in a communication system, the method comprising:
transmitting, by an edge enabler client (EEC) of the terminal to a server of an edge data network (EDN), a request message including an indication indicating that an EEC triggering is requested, the server of the EDN including an edge configuration server (ECS) or an edge enabler server (EES);
receiving, from the server, a message including information on a trigger payload based on the request message; and
performing a procedure selected based on the trigger payload,
wherein the trigger payload includes information indicating a procedure over EDGE-1 or a procedure over EDGE-4.

2. The method of claim 1, wherein the request message is transmitted based on an application triggering being supported.

3. The method of claim 1, wherein the message is received from the server via a short message service (SMS)-service center (SC) (SMS-SC).

4. The method of claim 1, wherein the procedure over EDGE-1 includes an edge application server (EAS) discovery procedure and the procedure over EDGE-4 includes a service provisioning procedure, and
wherein the trigger payload further includes information on a server associated with the selected procedure.

5. The method of claim 4, wherein the information on the server associated with the selected procedure includes an identifier and an address of the server associated with the selected procedure, and
wherein, in case that the selected procedure is the EAS discovery procedure, the information on the server associated with the selected procedure includes an identifier and an address of the EES.

6. A method performed by a server of an edge data network (EDN) in a communication system, the method comprising:
receiving, from a terminal, a request message including an indication indicating that an edge enabler client (EEC) triggering is requested; and
transmitting, to the terminal, a message including information on a trigger payload based on the request message, the trigger payload including information indicating a procedure over EDGE-1 or a procedure over EDGE-4,
wherein the server includes an edge configuration server (ECS) or an edge enabler server (EES), and
wherein a procedure selected based on the trigger payload is performed with the ECS or the EES.

7. The method of claim 6, wherein the message is transmitted based on a trigger delivery request message, the trigger delivery request message being transmitted from the server to a network exposure function (NEF) based on the indication, and
wherein the trigger delivery request message further includes at least one of a generic public subscription identifier (GPSI), an application function (AF) identifier (ID), a trigger reference number, or an application port ID.

8. The method of claim 7, wherein the message is transmitted from the NEF to the terminal via a short message service (SMS)-service center (SC) (SMS-SC).

9. The method of claim 6, wherein the procedure over EDGE-1 includes an edge application server (EAS) discovery procedure and the procedure over EDGE-4 includes a service provisioning procedure, and
wherein the trigger payload further includes information on a server associated with the selected procedure.

10. The method of claim 9, wherein the information on the server associated with the selected procedure includes an identifier and an address of the server associated with the selected procedure, and
wherein, in case that the selected procedure is the EAS discovery procedure, the information on the server associated with the selected procedure includes an identifier and an address of the EES.

11. A terminal in a communication system, the terminal comprising:
a transceiver; and
a controller including an edge enabler client (EEC) configured to:
control the transceiver to transmit, a server of an edge data network (EDN), a request message including an indication indicating that an EEC triggering is requested, the server including an edge configuration server (ECS) or an edge enabler server (EES),
control the transceiver to receive, from the server, a message including information on a trigger payload based on the request message and
perform a procedure selected based on the trigger payload,
wherein the trigger payload includes information indicating the procedure over EDGE-1 or a procedure over EDGE-4.

12. The terminal of claim 11, wherein the controller is further configured to control the transceiver to transmit, to the server, the request message, based on an application triggering being supported.

13. The terminal of claim 11, wherein the message is received from the server via a short message service (SMS)-service center (SC) (SMS-SC).

14. The terminal of claim 11, wherein the procedure over EDGE-1 includes an edge application server (EAS) discovery procedure and the procedure over EDGE-4 includes a service provisioning procedure, and
wherein the trigger payload further includes information on a server associated with the selected procedure.

15. The terminal of claim 14, wherein the information on the server associated with the selected procedure includes an identifier and an address of the server associated with the selected procedure, and
wherein, in case that the selected procedure is the EAS discovery procedure, the information on the server associated with the selected procedure includes an identifier and an address of the EES.

16-20. (canceled)
